(19) United States
(12) Patent Application Publication
(10) Pub. No.: US 2009/0140590 A1
(43) Pub. Date: Jun. 4, 2009

(54) PERMANENT MAGNET TYPE MAGNETIC POLE CORE STRUCTURE CAPABLE OF MINIMIZING COGGING TORQUE FOR ROTATING ELECTRIC MACHINE

(75) Inventor: SHIH-WEI HUNG, Taipei City (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/178,952

(22) Filed: Jul. 24, 2008

(30) Foreign Application Priority Data
Dec. 4, 2007 (TW) 096146022

(51) Int. Cl. H02K 21/12

(52) U.S. Cl. 310/156.32

(57) ABSTRACT

A permanent magnet type magnetic pole core structure capable of minimizing the cogging torque for a rotating electric machine such as an electric motor or a power generator is disclosed. The rotating electric machine comprises: a magnetic pole core and an armature core. The magnetic pole core comprises a plurality of magnetic pole structures in a number of M, while each magnetic pole structure comprises at least one permanent magnet and can be used for defining two reference lines with an expanding angle sandwiched therebetween, and a periphery of the magnetic pole core enclosing the pole structure defining between the two reference lines is divided into a first arc surface, a second arc surface and a third arc surface. In an exemplary embodiment, the armature core comprises a plurality of slot structures in a number of S. The ratio of the amount of slot structure to the amount of the magnetic pole structure, i.e. S/M, is 3/2. With the aforesaid permanent magnet type magnetic pole core structure, the cogging torque of the rotating electric machine can be minimized.

### BACKGROUND OF THE INVENTION

1. Field of the Invention

The present invention generally relates to a permanent magnet type magnetic pole core structure capable of minimizing the cogging torque for a rotating electric machine and, more particularly, to a permanent magnet type magnetic pole core structure capable of minimizing the cogging torque for a rotating electric machine such as an electric motor or a power generator.

2. Description of the Prior Art

In order to enhance the efficiency, increase the power density and minimize the relative size of a rotating electric machine (such as an electric motor and a power generator), a permanent magnet is used as a constant magnetic source. With the development in processing and materials, the permanent magnet with high magnetic energy product is widely used in rotating electric machines.

Please refer to FIG. 1, wherein the rotating electric machine comprises: a stator 91, rotor 92 and a magnet 93. The periphery of the rotor (magnetic pole core) 92 comprises a plurality of arc surfaces with the same radius. When the permanent magnet 93 is used as a constant magnetic source rotating without a load, the characteristics in the magnetic flux path of the rotating electric machine are controlled by the constant magnetic field. During rotation, the equivalent magnetic reluctance in the magnetic flux path changes periodically based on the rotating angle. A magnetic reluctance torque, also referred to as stop torque, is caused due to the rate of change of the magnetic reluctance in response to the rotating angle and is proportional to the square of the equivalent magnetic flux in the air gap. The torque generated by the constant magnetic field from the permanent magnet in order to match the minimum equivalent magnetic reluctance in the magnetic flux path of the core is referred to as a cogging torque.

When the driving torque is not much larger than the cogging torque, an undesired output torque ripple is generated to cause vibration and noise and further affect the control precision, especially when rotating at a very low rate. Therefore, the present invention provides a permanent magnet type magnetic pole core structure capable of minimizing the cogging torque for a rotating electric machine so as to enhance the performance of the rotating electric machine comprising a permanent magnet.

The cogging torque in a rotating electric machine is expressed as:

$${T}_{cog} = - \frac{1}{2} {φ}^{2} \frac{d {R}_{mag}}{d θ}$$

wherein T_{cog} is the cogging torque; φ is the equivalent magnetic flux in the air gap; R_{mag} is the equivalent magnetic reluctance in the magnetic flux path; and θ is the rotating angle.

The change of equivalent magnetic reluctance in the magnetic flux path can be expressed as a periodical function of the rotating angle. Accordingly, the cogging torque is the equivalent magnetic reluctance in the magnetic flux path differentiated by the rotating angle. Alternatively, the cogging torque can also be expressed as a symmetric period function of the rotating angle, which can be expressed in Fourier series.

To minimize the effect of the cogging torque on the rotating electric machine, two methods can be used. The first method is to reduce the equivalent magnetic flux in the air gap. The output cogging torque is proportional to the square of the equivalent magnetic flux in the air gap and the equivalent magnetic flux in the air gap is proportional to the effective output magnetic torque. Reducing the equivalent magnetic flux in the air gap does not only minimize the cogging torque but also reduce the effective output magnetic torque. Therefore, such a method is seldom used to minimize the cogging torque.

The second method is to reduce the rate of change of the equivalent magnetic reluctance in the magnetic flux path in response to the rotating angle. Ideally, as long as the equivalent magnetic reluctance in the magnetic flux path is kept constant during rotation (that is to say, the rate of change is zero), no cogging torque will be generated. Related designs concerning the reduction of the rate of change of the equivalent magnetic reluctance in the magnetic flux path in response to the rotating angle are capable of preventing negative influences on the effective output magnetic torque and other characteristics of the rotating electric machine. Therefore, such a method is often used to minimize the cogging torque.

For the second method, there are many factors that cause the equivalent magnetic reluctance in the magnetic flux path to change. Mainly, the change of the magnetic flux path due to the relative rotating movement between the tooth slot structure of the armature core disposed for accommodating the winding and the magnetic pole core causes the change of the equivalent magnetic reluctance in the magnetic flux path. For example, the transition of the magnetic pole corresponding to the tooth, the magnetic reluctance in the air gap due to the slot opening, the change of the magnetic flux intensity and magnetic saturation directly or indirectly cause the change of the equivalent magnetic reluctance in the magnetic flux path, leading to the cogging torque. The second method is implemented as described hereinafter.

To eliminate the change of the equivalent magnetic reluctance in the magnetic flux path, a skew tooth slot or a skew magnetic pole can be used to select one from the tooth slot of the armature and the magnetic pole of the permanent magnet to generate a phase shift due to the change of the axial magnetic reluctance by continuously or piecewise rotating a specific angle so that the total change of the magnetic reluctance is reduced, leading to a reduced total cogging torque. However, such a method using skew rotation results in increased cost and time in manufacturing, assembly and inspection.

Alternatively, the cogging torque can be reduced by using a specific ratio of the amount of slots to the amount of magnetic poles. Generally, the larger the lowest common multiple of the amount of slots and the amount of magnetic poles, the smaller the cogging torque. Using such a specific ratio, restricted windings are required and, sometimes, undesired radial forces occur. For example, for a rotating electric machine comprising 9 slots and 8 magnetic poles, a radial force occurs for such a slot-to-pole ratio, which causes radial loading on the bearing and leads to vibration and noise. Therefore, such a method is not suitable for low-vibration and low-noise applications.

Alternatively, a rotating electric machine can comprise multiple magnetic pole cores or multiple armature cores to reduce the cogging torque. The multiple magnetic pole cores or multiple armature cores are used to cause two cogging torques with the same intensity and an electrical angle different of 180 degrees so as to balance off the cogging torque during rotation. However, such a design is only useful for a rotating electric machine really requiring multiple magnetic pole cores or multiple armature cores. Moreover, such a design results in increased cost and time in manufacturing, assembly and inspection.

Alternatively, another method is to reduce the change of the total equivalent magnetic reluctance by changing the surface or internal structure of the tooth shoe of the armature core for adjacent air gaps or changing the surface or internal structure of the magnetic pole for adjacent air gaps. For example, the number of slots on the tooth shoe surface can be increased to enlarge the surface arc. Alternatively, the tooth shoe can comprise materials with different permeability. Alternatively, the arc of the surface-mounted magnet can be changed. Alternatively, the magnetic pole can comprise materials with different permeability. All these approaches can suppress the change of the total equivalent magnetic reluctance.

In addition to the aforesaid methods, the present invention provides a permanent magnet type magnetic pole core structure capable of minimizing the cogging torque for a rotating electric machine.

### SUMMARY OF THE INVENTION

It is an object of the present invention to provide to a permanent magnet type magnetic pole core structure capable of minimizing the cogging torque for a rotating electric machine such as an electric motor or a power generator.

In order to achieve the foregoing object, the present invention provides a permanent magnet type magnetic pole core structure capable of minimizing the cogging torque for a rotating electric machine, the permanent magnet type magnetic pole core structure comprising:

an armature core, comprising a plurality of armature core slots, an armature central line and an armature core center; and

a magnetic pole core, comprising a plurality of pairs of magnetic poles, a magnetic pole central line and a magnetic pole core center, each of the magnetic poles comprising at least a permanent magnet;

wherein a air gap is disposed between the magnetic pole core and armature core; an expanding angle is included in the periphery of each of the magnetic poles, the expanding angle comprising a first arc surface, a second arc surface and a third arc surface;

wherein the second arc surface and the third arc surface are adjacent to two sides of the first arc surface being equally divided by the magnetic pole central line and protruding in the air gap, while the second arc surface and the third arc surface are recessed in the air gap;

wherein the ratio of the amount of the armature core slots to that of the magnetic poles is 3/2.

It is preferable that the permanent magnet faces the armature core tooth when the magnetic pole core center and the armature core center are overlapped and the magnetic pole central line and the armature central line are overlapped.

It is preferable that the first reference line is formed by connecting the magnetic pole core center, a counterclockwise peak on the surface of the permanent magnet facing the air gap, and a node where a tooth comb of counterclockwise adjacent tooth of the armature core is connected to a tooth shoe and the third reference line is formed by connecting the magnetic pole core center and a joint where a tooth shoe of counterclockwise adjacent tooth of the armature core is connected to a tooth slot when the magnetic pole central line rotates counterclockwise and differs from the armature central line by a specific angle.

It is preferable that the second reference line is formed by connecting the magnetic pole core center, a clockwise peak on the surface of the permanent magnet facing the air gap, and a node where a tooth comb of clockwise adjacent tooth of the armature core is connected to a tooth shoe and the fourth reference line is formed by connecting the magnetic pole core center and a joint where a tooth shoe of clockwise adjacent tooth of the armature core is connected to a tooth slot when the magnetic pole central line rotates clockwise and differs from the armature central line by a specific angle.

It is preferable that the magnetic poles are symmetric based on the magnetic pole central line when magnetic pole central line and armature central line are overlapped.

It is preferable that an air gap is disposed on both sides of the permanent magnet.

### BRIEF DESCRIPTION OF THE DRAWINGS

The objects, spirits and advantages of the several embodiments of the present invention will be readily understood by the accompanying drawings and detailed descriptions, wherein:

FIG. 1 is an enlarged view of part of a general magnetic pole core and armature core in a conventional built-in permanent magnet type;

FIG. 2 is a diagram showing an armature core used with a permanent magnet type magnetic pole core structure capable of minimizing the cogging torque for a rotating electric machine according to the present invention;

FIG. 3 is a diagram showing an armature core used with a permanent magnet type magnetic pole core structure capable of minimizing the cogging torque for a rotating electric machine according to the present invention;

FIG. 4 is a diagram showing a permanent magnet type magnetic pole core structure capable of minimizing the cogging torque for a rotating electric machine according to a first embodiment of the present invention;

FIG. 5 is an enlarged view of part of a permanent magnet type magnetic pole core structure capable of minimizing the cogging torque for a rotating electric machine according to a first embodiment of the present invention;

FIG. 6 shows the cogging torque of a permanent magnet type magnetic pole core structure capable of minimizing the cogging torque for a rotating electric machine according to a first embodiment of the present invention;

FIG. 7 is a diagram showing a permanent magnet type magnetic pole core structure capable of minimizing the cogging torque for a rotating electric machine according to a second embodiment of the present invention;

FIG. 8 is an enlarged view of part of a permanent magnet type magnetic pole core structure capable of minimizing the cogging torque for a rotating electric machine according to a second embodiment of the present invention; and

FIG. 9 shows the cogging torque of a permanent magnet type magnetic pole core structure capable of minimizing the cogging torque for a rotating electric machine according to a second embodiment of the present invention.

### DETAILED DESCRIPTION OF THE PREFERRED EMBODIMENT

The present invention can be exemplified but not limited by the preferred embodiments as described hereinafter.

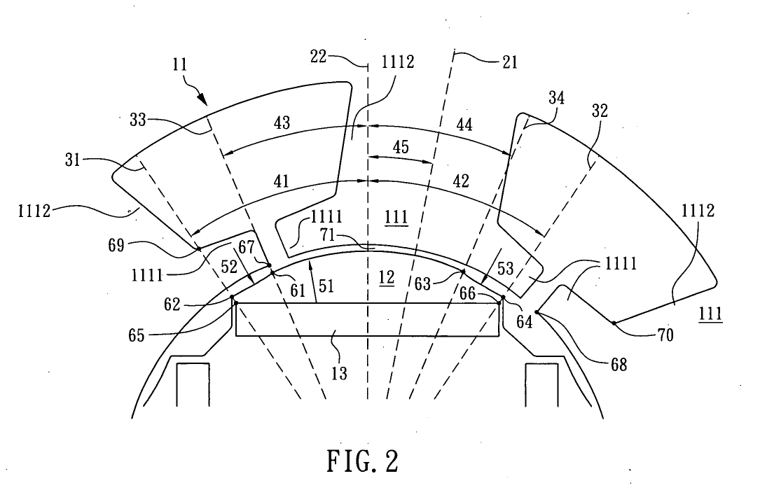

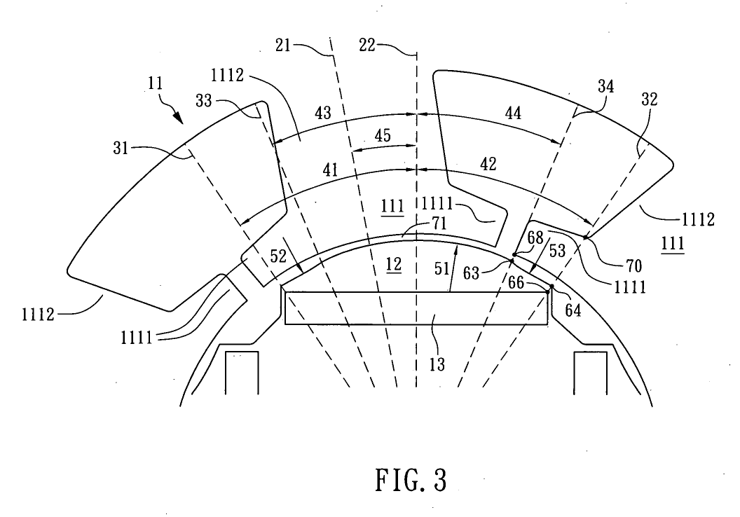

Please refer to FIG. 2 and FIG. 3, wherein a rotating electric machine comprise a magnetic pole core 12 and an armature core 11. The magnetic pole core 12 comprises a plurality of magnetic pole structures in a number of M, while each magnetic pole structure comprises at least one permanent magnet. The armature core 11 comprises a plurality of slot structures in a number of S. The ratio of the amount of slot structure to the amount of the magnetic pole structure, i.e. S/M, is 3/2. A first expanding angle 41 is included between the first reference line 31 and the magnetic pole central line 22. The first reference line 31 passes through the permanent magnet 13 and heads toward a first peak 65 on the surface of a first air gap 71. A second expanding angle 42 is included between the second reference line 32 and the magnetic pole central line 22. The second reference line 32 passes through the permanent magnet 13 and heads toward a second peak 66 on the surface of a first air gap 71. The first expanding angle 41 and the second expanding angle 42 are sandwiched between the first reference line 31 and the second reference line 32 to enclose a periphery of the magnetic pole core 12, which is divided into a first arc surface 51, a second arc surface 52 and a third arc surface 53. The first arc surface 51 is equally divided by the magnetic pole central line 22 and faces the first air gap 71. The second arc surface 52 and the third arc surface 53 are adjacent to two sides of the first arc surface 51. The back of the second arc surface 52 and the third arc surface 53 faces the first air gap 71. A third expanding angle 43 is included between the third reference line 33 and the magnetic pole central line 22. A fourth expanding angle 44 is included between the fourth reference line 34 and the magnetic pole central line 22. The expanding angle of the second arc surface 52 is the first expanding angle 41 subtracted by the third expanding angle 43. The expanding angle of the third arc surface 53 is the second expanding angle 42 subtracted by the fourth expanding angle 44.

When the magnetic pole central line 22 rotates counterclockwise and differs from the armature central line 21 by a specific difference angle 45, the third expanding angle 43 is included between the magnetic pole central line 22 and the third reference line 33 to pass through a first joint 61 of the first arc surface 51 and the second arc surface 52 and a first corner 67 at the bottom of the tooth shoe 1111 of the tooth 111 counterclockwise adjacent to the tooth 111 facing the permanent magnet 13. The first expanding angle 41 is included between the first reference line 31 and the magnetic pole central line 22 to pass a first peak 65 on the surface of the permanent magnet 13 facing the air gap 71, a second joint 62 between the second arc surface 52 and counterclockwise adjacent magnetic pole and a first node 69 where a tooth comb 1112 of counterclockwise adjacent tooth 111 of the armature core 11 is connected to a tooth shoe 1111. In short, the first reference line 31 passes through the first peak 65, the second joint 62 and the first node 69. The expanding angle of the second arc surface 52 is between the third reference line 33 and the first reference line 31. The expanding angle between the third reference line 33 and the first reference line 31 is the first expanding angle 41 subtracted by the third expanding angle 43.

When the magnetic pole central line 22 rotates clockwise and differs from the armature central line 21 by a specific difference angle 45, the fourth expanding angle 44 is included between the magnetic pole central line 22 and the fourth reference line 34 to pass through a third joint 63 of the first arc surface 51 and the third arc surface 53 and a second corner 68 at the bottom of the tooth shoe 1111 of the tooth 111 clockwise adjacent to the tooth 111 facing the permanent magnet 13. The second expanding angle 42 is included between the second reference line 32 and the magnetic pole central line 22 to pass a second peak 66 on the surface of the permanent magnet 13 facing the air gap 71, a joint 64 between the third arc surface 53 and clockwise adjacent magnetic pole and a second node 70 where a tooth comb 1112 of clockwise adjacent tooth 111 of the armature core 11 is connected to a tooth shoe 1111. The expanding angle of the third arc surface 53 is between the fourth reference line 34 and the second reference line 32. The expanding angle is the second expanding angle 42 subtracted by the fourth expanding angle 44.

The expanding angle 41+42 is sandwiched between the reference lines to enclose a periphery of the magnetic pole core 12, which is divided into a first arc surface 51, a second arc surface 52 and a third arc surface 53. The magnetic pole central line 22 counterclockwise or clockwise rotates and differs from the armature central line 21 by a specific difference angle 45.

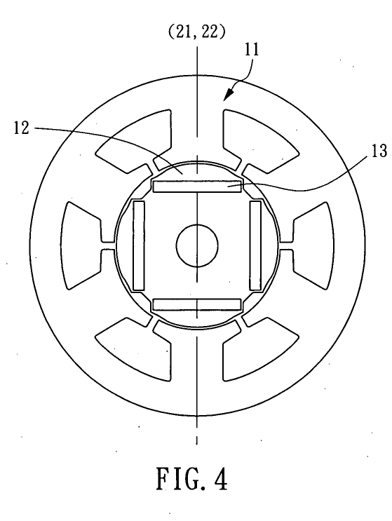

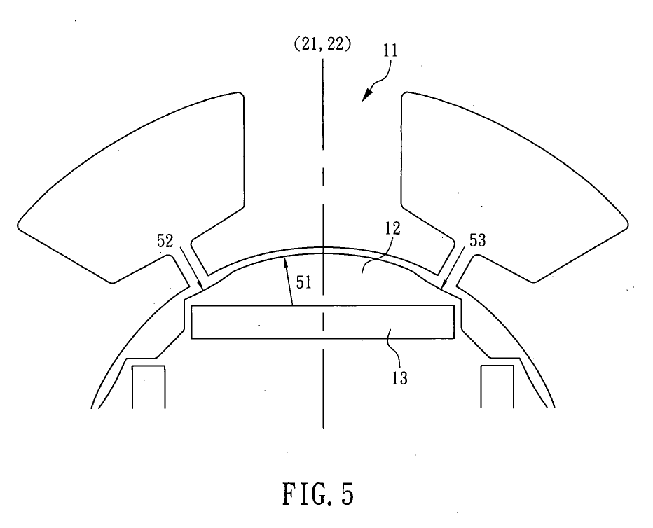

Please refer to FIG. 4 and FIG. 5 for the whole structure and the enlarged view of part of a permanent magnet type magnetic pole core structure with 4 poles and 6 slots according to a first embodiment of the present invention. When the magnetic pole central line 22 passes through the center of the magnetic pole core 12 and the center of the permanent magnet 13 and the armature central line 21 passes through the center of the armature core 11 and the center of the tooth 111 the permanent magnet 13 faces, the center of the magnetic pole core 12 and the center of the armature core 11 are overlapped.

When the magnetic pole central line 22 and the armature central line 21 are overlapped, that is, the permanent magnet 13 faces the tooth 111 of the armature core 11, the expanding angle 43=44 and 41=42. Each magnetic pole is symmetric and repeated along the magnetic pole central line 22.

According to the present invention, the cogging torque can be eliminated during rotation using the proper permanent magnet 13 of the magnetic pole core 12 and the slot of the armature core 11. The expanding angle in the periphery defined by the reference lines 31 and 32 of the magnetic pole core 12 comprises the first arc surface 51, the second arc surface 52 and the third arc surface 53.

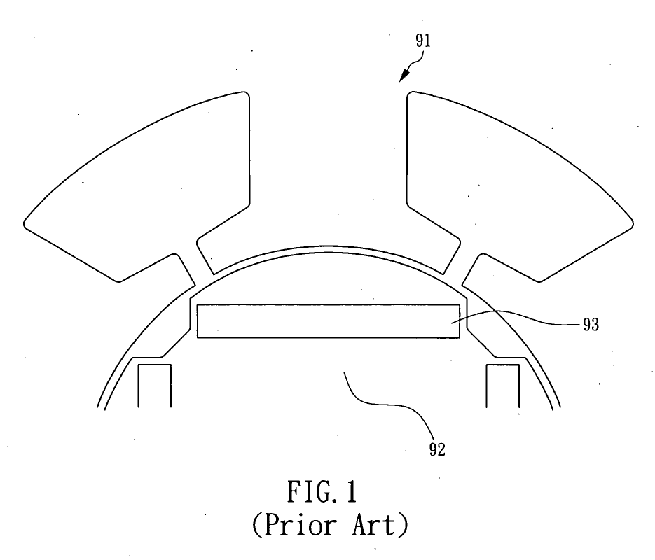

In the first embodiment, a rotating electric machine comprising 4 poles and 6 slots is different from the structure in FIG. 1 in that, in the first embodiment, the periphery defined by the reference lines can be divided into the first arc surface, the second arc surface and the third arc surface so that the cogging torque of the rotating electric machine can be effectively reduced.

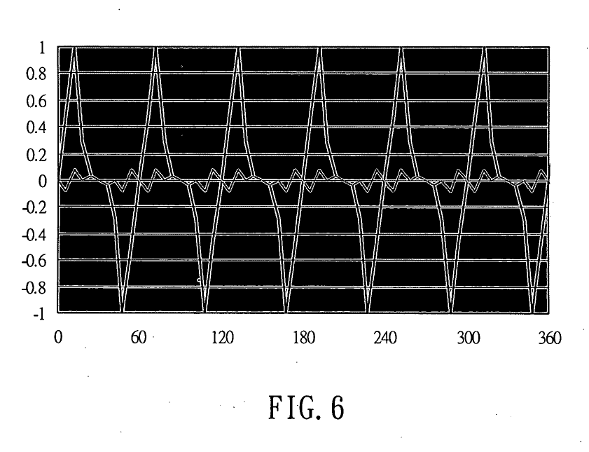

Please refer to FIG. 6, in which the cogging torque in the longitudinal axis is normalized and the rotating angle is expanded as 360 degree electric angle in the transversal axis. According to the first embodiment of the present invention, the peak value of the cogging torque is reduced by 90% to achieve minimized cogging torque of the rotating electric machine.

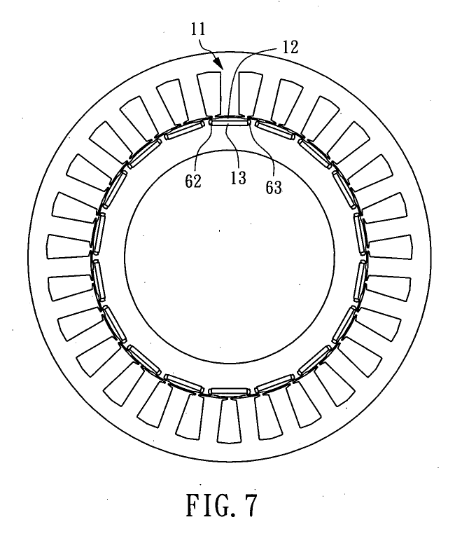

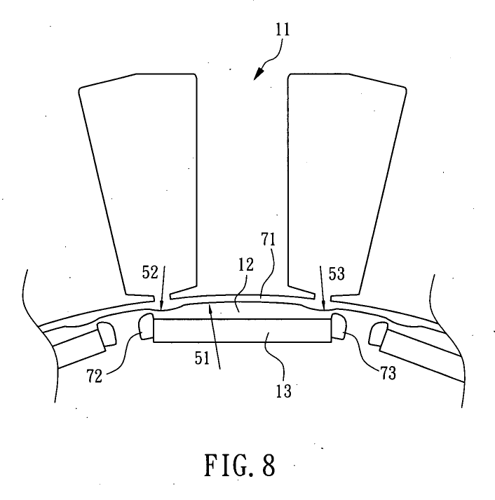

Please refer to FIG. 7 and FIG. 8, for the whole structure and the enlarged view of part of a permanent magnet type magnetic pole core structure with 18 poles and 27 slots according to a second embodiment of the present invention.

When the magnetic pole central line 22 passes through the center of the magnetic pole core 12 and the center of the permanent magnet 13 and the armature central line 21 passes through the center of the armature core 11 and the center of the tooth 111 the permanent magnet 13 faces, the center of the magnetic pole core 12 and the center of the armature core 11 are overlapped. The disclosure in FIG. 7 and FIG. 8 is similar to that in FIG. 4 and FIG. 5. For example, the periphery of the magnetic pole core enclosing the pole structure defining between the two reference lines is divided into a first arc surface, a second arc surface and a third arc surface. Furthermore, the magnetic pole core 12 comprises a second air gap 72 and a third air gap 73 on both sides of the permanent magnet 13 so as to reduce magnetic leakage.

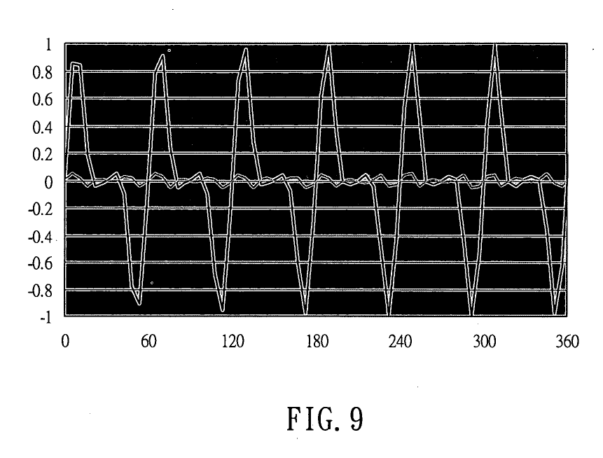

Please refer to FIG. 9, in which the cogging torque in the longitudinal axis is normalized and the rotating angle is expanded as 360 degree electric angle in the transversal axis. According to the first embodiment of the present invention, the peak value of the cogging torque is reduced by 90% to achieve minimized cogging torque of the rotating electric machine.

Accordingly, the present invention discloses a permanent magnet type magnetic pole core structure capable of minimizing the cogging torque for a rotating electric machine such as an electric motor or a power generator. Therefore, the present invention is novel, useful, and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A permanent magnet type magnetic pole core structure capable of minimizing the cogging torque for a rotating electric machine, the permanent magnet type magnetic pole core structure comprising:
an armature core, comprising a plurality of armature core slots, an armature central line and an armature core center; and
a magnetic pole core, comprising a plurality of pairs of magnetic poles, a magnetic pole central line and a magnetic pole core center, each of the magnetic poles comprising at least a permanent magnet;
wherein a air gap is disposed between the magnetic pole core and armature core; an expanding angle is included in the periphery of each of the magnetic poles, the expanding angle comprising a first arc surface, a second arc surface and a third arc surface;
wherein the second arc surface and the third arc surface are adjacent to two sides of the first arc surface being equally divided by the magnetic pole central line and protruding in the air gap, while the second arc surface and the third arc surface are recessed in the air gap;
wherein the ratio of the amount of the armature core slots to that of the magnetic poles is 3/2.

2. The permanent magnet type magnetic pole core structure capable of minimizing the cogging torque for a rotating electric machine as recited in claim 1, wherein the permanent magnet faces the armature core tooth when the magnetic pole core center and the armature core center are overlapped and the magnetic pole central line and the armature central line are overlapped.

3. The permanent magnet type magnetic pole core structure capable of minimizing the cogging torque for a rotating electric machine as recited in claim 2, wherein a first reference line is formed by connecting the magnetic pole core center, a counterclockwise peak on the surface of the permanent magnet facing the air gap, and a node where a tooth comb of counterclockwise adjacent tooth of the armature core is connected to a tooth shoe and a third reference line is formed by connecting the magnetic pole core center and a joint where a tooth shoe of counterclockwise adjacent tooth of the armature core is connected to a tooth slot when the magnetic pole central line rotates counterclockwise and differs from the armature central line by a specific angle.

4. The permanent magnet type magnetic pole core structure capable of minimizing the cogging torque for a rotating electric machine as recited in claim 2, wherein a second reference line is formed by connecting the magnetic pole core center, a clockwise peak on the surface of the permanent magnet facing the air gap, and a node where a tooth comb of clockwise adjacent tooth of the armature core is connected to a tooth shoe and a fourth reference line is formed by connecting the magnetic pole core center and a joint where a tooth shoe of clockwise adjacent tooth of the armature core is connected to a tooth slot when the magnetic pole central line rotates clockwise and differs from the armature central line by a specific angle.

5. The permanent magnet type magnetic pole core structure capable of minimizing the cogging torque for a rotating electric machine as recited in claim 4, wherein the magnetic poles are symmetric based on the magnetic pole central line when magnetic pole central line and armature central line are overlapped.

6. The permanent magnet type magnetic pole core structure capable of minimizing the cogging torque for a rotating electric machine as recited in claim 1, wherein an air gap is disposed on both sides of the permanent magnet.
